(19) United States
(12) Patent Application Publication
(10) Pub. No.: US 2026/0298855 A1
(43) Pub. Date: Oct. 1, 2026

(54) RIBBON CABLE WITH TEMPERATURE SENSOR, CONNECTOR ASSEMBLY, AND METHOD

(71) Applicant: SAINT-GOBAIN GLASS FRANCE, COURBEVOIE (FR)

(72) Inventors: Bernhard REUL, HERZOGENRATH (DE); Francois HERMANGE, HERZOGENRATH (DE); Hadi RASTEGAR, HERZOGENRATH (DE)

(21) Appl. No.: 18/880,473

(22) PCT Filed: Jun. 26, 2023
(86) PCT No.: PCT/EP2023/067262

§ 371 Date: Dec. 31, 2024

(30) Foreign Application Priority Data
Jul. 14, 2022 (EP) 22184868.2

(51) Int. Cl. G01N 25/72; G01K 7/16; H01B 7/08; H01R 12/77

(52) U.S. Cl. CPC G01N 25/72; G01K 7/16; H01B 7/08; H01R 12/771

(57) ABSTRACT

A ribbon cable having a carrier film with at least one electrical conductor track, wherein the carrier film has a first connector region at a first end and a second connector region at a second end, wherein the first connector region can be arranged between two panes of a laminated glass pane, and the second connector region can be led out of the laminated glass pane between the two panes, and wherein the at least one electrical conductor track in the first connector region can make electrical contact with an electrical functional element, wherein the carrier film has a temperature sensor and two auxiliary conductor tracks, and the auxiliary conductor tracks make electrical contact with the temperature sensor, so that an ohmic resistance can be measured between the auxiliary conductor tracks.

The invention relates to a ribbon cable with a temperature sensor and a connector assembly with a laminated glass pane and a ribbon cable according to the invention, a method for temperature measurement, and the use of a ribbon cable according to the invention.

Glazing units in buildings and vehicles are increasingly being provided with large-area, electrically-conductive functional layers that are transparent to visible light. In particular, for reasons of energy-saving and comfort, high demands are placed on glazing units in terms of their thermal insulation properties. It is thus desirable to avoid high heat input from solar radiation, which leads to excessive heating of the interior and in turn results in high energy costs for the necessary air conditioning. This can be remedied by layer systems with which the light transmission and thus the heat input due to sunlight can be controlled by applying an electrical voltage. Electrochromic layer systems are known, for example, from EP 0867752A1, US 2007/0097481A1, and US 2008/0169185A1. Such layered systems are usually switched by external switches located in the vicinity of the glazing unit. A further function of electrical functional coatings is aimed at keeping the field of vision of a vehicle windshield free of ice and fogging. Electrical heating layers (see, e.g., WO 2010/043598A1) , which cause a targeted heating of the pane by applying an electrical voltage, are known. The voltage applied to the electrical heating layer is usually controlled by external switches, which in vehicles are integrated into a dashboard, for example. For example, it is known from DE 10106125A1, DE 10319606A1, EP 0720249A2, US 2003/0112190 A1, and DE 198 43 338 C2 to use an electrical functional layer as an area antenna. For this purpose, the functional layer is galvanically or capacitively coupled to a coupling electrode, and the antenna signal is made available in the marginal region of the pane. The antenna signal decoupled from the area antenna is fed to an antenna amplifier, which in motor vehicles is connected to the metallic body, thus providing a high-frequency reference potential for the antenna signal.

Such laminated glass panes usually consist of at least two rigid individual glass panes, which are adhesively connected to one another by a thermoplastic adhesive layer. The electrical functional layer is located between the individual glass panes and is typically electrically connected to the external vicinity via a flat conductor. The reason for this is that suitable flat conductors generally have an overall thickness of no more than 0.3 mm. Such thin, flat conductors can be embedded in the thermoplastic adhesive layer between the individual glass panes without difficulty. Examples of flat conductors for contacting electrical functional layers in laminated glass panes in the automotive sector can be found in DE 20 2021 105 230U1, DE 42 35 063A1 , DE 20 2004 019 286U1, EP 2 695 233B1, or DE 93 13 394U1 .

The use of flat conductors in laminated glass panes with electrical functional elements in the form of electro-optical components is also known. Such laminated glass panes are often referred to as active glazing units. The electro-optical components are two-dimensional structures with electrically-controllable optical properties of an active layer. This means that the optical properties of the active layer and in particular its transparency, scattering behavior, or luminosity can be controlled by an electrical voltage. Examples of electro-optical components are electrochromic elements, SPD (suspended particle device) elements known for example from EP 0876608 B1 and WO 2011033313A1, PDLC (polymer dispersed liquid crystal) elements known for example from DE 10 2008 026 339 A1 or DE 20 2020 005 499U1, and elements based upon guest-host cells.

The electrical contacting of electrical functional elements and electro-optical components is usually made by busbars, which are applied in the marginal region of the functional layer or the electro-optical component and make electrically-conductive contact with it. By connecting the busbars to an external voltage source—typically via flat conductors attached to the busbars—a voltage is applied, and the functional layer or electro-optical component is switched.

In practice, ribbon cables are used for more complex control tasks, which are provided with a plurality of electrical conductor tracks. The electrical conductor tracks are very thin, with thicknesses in the range of 0.03 mm to 0.1 mm, for example, and consist of copper, for example, which has proven its worth, since it has good electrical conductivity along with good processability, and, at the same time, the material costs are low. The electrical conductor tracks are typically arranged on electrically-insulating, polymeric carrier films and covered by electrically-insulating, polymeric cover films.

Such thin electrical conductor tracks—in particular, if laminated in sections into a laminated glass pane—are susceptible to damage—for example, by bending over a sharp edge or corrosion.

Electrical functional elements are often highly temperature-sensitive. In particular, electrical functional elements with electrically-controllable optical properties change their optical properties with usually increasing temperature, up to permanent destruction of their properties.

In contrast, the object of the present invention is to provide a ribbon cable with a temperature sensor that is nevertheless inexpensive to produce, easy to handle, and can be easily laminated into a laminated glass pane.

A further aspect of the invention relates to providing an improved connector assembly having a laminated glass pane and a ribbon cable with a temperature sensor and electrically contacting an electrical functional element of the laminated glass pane, allowing flexible electrical contacting of the ribbon cable outside the laminated glass pane and a spot or continuous measurement of the temperature of the electrical functional element in the laminated glass pane.

According to the proposal of the invention, these and further objects are achieved by a ribbon cable according to the independent claim. Preferred embodiments along with a connector assembly with a ribbon cable and a control system arise from the subclaims. A method according to the invention and a use of the ribbon cable according to the invention and of the connector assembly according to the invention arise from subsidiary claims.

The invention relates to a ribbon cable, comprising at least:
a carrier film having at least one, and preferably at least two, electrical conductor tracks, wherein the carrier film has a first connector region at at least one first end and a second connector region at at least one second end, and wherein the carrier film has a temperature sensor and two auxiliary conductor tracks, and the two auxiliary conductor tracks make electrical contact with the temperature sensor, so that an ohmic resistance can be measured between the two ends of the auxiliary conductor tracks.

This means that one end of each auxiliary conductor track is electrically connected to one of the two connectors of the temperature sensor, so that the ohmic resistance can be measured between the respective other ends of the auxiliary conductor tracks.

Advantageously, the connector of the temperature sensor is connected to the respective auxiliary conductor track via a soldered connection or an adhesive connection with an electrically-conductive adhesive. This ensures a particularly good and durable electrical line connection under the conditions of the respective use of the ribbon cable according to the invention.

With the ribbon cable according to the invention, the first connector region can advantageously be arranged between two panes of a laminated glass pane, and the second connector region can be led out of the laminated glass pane between the two panes, and the electrical conductor track can make electrical contact with an electrical functional element in the first connector region.

In a further advantageous embodiment of a ribbon cable according to the invention, the temperature sensor is arranged at the first connector region of the carrier film.

In a further advantageous embodiment of a ribbon cable according to the invention, the auxiliary conductor tracks and/or the temperature sensor are arranged in the marginal region of the carrier film. Preferably, the distance between the auxiliary conductor tracks and/or the temperature sensor and the margin of the carrier film is less than 5 mm, and particularly preferably equal to or less than 3 mm.

In a further advantageous embodiment of a ribbon cable according to the invention, the first auxiliary conductor track, the temperature sensor, and the second auxiliary conductor track are routed in a loop shape and, preferably, substantially U-shape around the first connector region.

In a further advantageous embodiment of a ribbon cable according to the invention, at least one electrical conductor track and at least one auxiliary conductor track are arranged in one plane next to one another or in at least two, and preferably in exactly two or exactly three or exactly four, planes above one another.

In a further advantageous embodiment of a ribbon cable according to the invention, at least one electrical conductor track and both auxiliary conductor tracks are arranged in one plane next to one another or in at least two, and preferably in exactly two or exactly three or exactly four, planes above one another.

In a further advantageous embodiment of a ribbon cable according to the invention, at least one electrical conductor track is arranged on a first surface of an electrically-insulating carrier film, and at least one further conductor track and/or the auxiliary conductor tracks are arranged on the second surface of the carrier film.

In a further advantageous embodiment of a ribbon cable according to the invention, the at least one electrical conductor track and the auxiliary conductor tracks, and preferably the temperature sensor, are firmly connected to the first or second surface of the carrier film. Preferably, the at least one electrical conductor track and the auxiliary conductor tracks, and particularly preferably the temperature sensor, are bonded to the first or second surface of the carrier film, and preferably via adhesive layers. Alternatively, the temperature sensor can be fastened to the carrier film only via the electrical line connection to the auxiliary conductor track—for example, a solder connection.

In a further advantageous embodiment of a ribbon cable according to the invention, the temperature sensor is a resistance element or resistance thermometer, and preferably a measuring resistor or a thermistor (i.e., an electrical resistor whose value changes reproducibly with temperature). Particularly preferably, the temperature sensor is a platinum resistor, a nickel resistor, a hot-conductor component (a thermistor with negative temperature coefficients (NTC), also a called NTC thermistor), or a PTC component (a thermistor with positive temperature coefficients (PTC), also a called PTC thermistor). Such temperature sensors contain or consist of, for example, a layer of a pure metal such as platinum or nickel, or a ceramic (sintered metal oxide), or a semiconductor.

A temperature sensor consisting of an NTC thermistor with an ohmic resistance value at a temperature T of 25° C. of 1 kOhm to 100 kOhm and in particular of 5 kOhm to 20 kOhm, and, for example, 10 kOhm, is particularly advantageous.

In a further advantageous embodiment of a ribbon cable according to the invention, the temperature sensor has a measuring range of —40° C. to +150° C.

In a further advantageous embodiment of a ribbon cable according to the invention, the carrier film has a respective notch or recess on both sides of the temperature sensor, which extends from the margin of the carrier film preferably substantially in a straight line and particularly preferably at an angle of 90° into the interior of the carrier film. For this purpose, the auxiliary conductor tracks are preferably routed in a loop shape around the notches or recesses. The length of the notches is preferably at least 3 mm to 100 mm, more preferably from 4 mm to 20 mm, and in particular from 6 mm to 10 mm. The width of the notches is preferably from 0.1 mm to 10 mm, particularly preferably from 0.3 mm to 2 mm, and in particular from 0.3 mm to 0.7 mm. The notches or recesses make the section with the temperature sensor particularly flexible. This has the particular advantage that the temperature sensor, which is usually thicker than the rest of the connector region, can be inserted particularly well and with low stress during lamination in a laminated glass pane.

A further aspect of the invention relates to a connector assembly having a laminated glass pane and a ribbon cable according to the invention, comprising at least:
a laminated glass pane comprising a first pane and a second pane, which are connected to one another in terms of surface area via at least one thermoplastic intermediate layer,
an electrical functional element between the two panes,
a ribbon cable according to the invention with at least one electrical conductor track, a temperature sensor, and at least two auxiliary conductor tracks, wherein the ribbon cable has a first connector region at a first end and a second connector region at a second end, wherein the first connector region is arranged between the two panes, and the second connector region is led out of the laminated glass pane between the two panes, and wherein the electrical conductor tracks in the first connector region make electrical contact with the electrical functional element.

The connector assembly according to the invention thus comprises a laminated glass pane consisting of a first pane and a second pane, which are firmly connected to one another in terms of surface area via a thermoplastic intermediate layer.

The connector assembly further comprises an electrical functional element arranged between the two panes, along with a ribbon cable that serves for the electrical contacting of the electrical functional element-in particular, for the electrical connector of the functional element to an electrical control unit. The ribbon cable has a first connector region and a second connector region, wherein, along a direction of extension of the ribbon cable, the first connector region is located at a first end and the second connector region is located at a second end of the ribbon cable. The ribbon cable is partially laminated into the laminated glass pane, wherein the first end has the first connector region located between the two panes, and the second end has the second connector region located between the two panes and led out of the laminated glass pane and located outside of the laminated glass pane. Thereby, the electrical conductor tracks in the first connector region are in electrical contact with the electrical functional element and are preferably galvanically connected to it.

In general, the ribbon cable is a flat body with two opposite sides, which can optionally be made into either a planar or curved shape. In the planar (i.e., non-curved) state, the flat conductor is arranged in a plane. Generally, the ribbon cable is formed to be elongated and has two ends along its direction of extension.

An advantageous embodiment of a ribbon cable according to the invention comprises at least two electrical conductor tracks, wherein the electrical conductor tracks are arranged adjacent to one another or above one another at least in sections.

In a further advantageous embodiment of the invention, at least two electrical conductor tracks are arranged one above the other in at least two, and preferably in exactly two or exactly three or exactly four, planes. Here, “one above the other means” with respect to the extension plane of the ribbon cable, i.e., with respect to the plane spanned by the two larger dimensions of the ribbon cable. Advantageously, at least two conductor tracks are arranged congruently in the projection orthogonal to the extension plane. Alternatively, the conductor track can be formed larger in one plane and substantially occupy the plane within the ribbon cable—preferably minus an insulating marginal region—partially or completely. This increases the current carrying capacity of this conductor track.

In an advantageous embodiment of a ribbon cable according to the invention, at least one electrical conductor track is arranged on a first surface of an electrically-insulating carrier film, and at least one further conductor track is arranged on the second surface (i.e., the surface opposite the first surface with respect to the carrier film) of the carrier film.

In a further advantageous embodiment of a ribbon cable according to the invention, the electrical conductor tracks are firmly connected to the first or second surface of the carrier film. Preferably, the electrical conductor tracks are bonded to the first or second surface of the carrier film, and in particular via adhesive layers. Alternatively, the carrier film can be coated with the electrical conductor tracks, and in particular using a printing process-for example, a screen printing process.

In a further advantageous embodiment of a ribbon cable according to the invention, the ribbon cable has, between the conductor tracks of a plane, insulating regions—preferably consisting of sections of an insulation film. Advantageously, sections of an insulation film are also arranged at the margin of the ribbon conductor in each case.

In a further advantageous embodiment of a ribbon cable according to the invention, the conductor tracks have at least one electrically-insulating cover film on their surfaces facing away from the carrier film. Preferably, the conductor tracks or the sections of an insulation film are firmly connected to the cover film. Particularly preferably, the conductor tracks or the sections of an insulation film are bonded to the cover film, and in particular via adhesive layers. The carrier film and the cover film together form an insulating sheath that encases the electrical conductor tracks.

The width of the ribbon cable can be constant or can vary. In particular, the ribbon cable can be widened in the first connector region and/or second connector region.

In a further advantageous embodiment of a ribbon cable according to the invention, the maximum width bF of the ribbon cable—preferably within the laminated glass pane and/or at the exit point from the laminated glass pane—is from 6 mm to 40 mm, preferably from 20 mm to 40 mm, and in particular from 25 mm to 30 mm. In a further advantageous embodiment of a ribbon cable according to the invention, the maximum thickness dF of the ribbon cable—preferably within the laminated glass pane and/or at the exit point from the laminated glass pane—is from 150 μm to 600 μm, preferably from 300 μm to 400 μm, and in particular from 300 μm to 350 μm. Ribbon cables with such maximum dimensions—in particular, within the laminated glass pane and/or at the exit point from the laminated glass pane—can be laminated in particularly well or impair the stability of the laminated glass pane or disturb its visual appearance.

In an advantageous embodiment, the ribbon cable has a length of 5 cm to 150 cm, preferably of 10 cm to 100 cm, and in particular of 50 cm to 90 cm. It is understood that the length, width, and thickness of the ribbon cable may be adjusted to the requirements of each individual case. The direction of the length defines the direction of extension of the ribbon cable.

The carrier film, the cover film, and/or the insulation film preferably contain or consist of polyimide or polyether, and particularly preferably polyethylene terephthalate (PET) or polyethylene naphthalate (PEN). The cover film and/or the insulation film may also consist of an electrically-insulating lacquer, and preferably a polymer lacquer. The cover film and/or the insulation film may also contain or consist of thermoplastics and elastomers such as polyamide, polyoxymethylene, polybutylene terephthalate, or ethylene-propylene-diene rubber. Alternatively, potting materials such as acrylate or epoxy resin systems can be used as the cover film and/or insulation film.

The carrier film, the cover film, and/or the insulation film preferably have a thickness of 10 μm to 300 μm, particularly preferably of 25 μm to 200 μm, and in particular of 60 μm to 150 μm. The carrier film, the cover film, and/or the insulation film are bonded to the conductor tracks via an adhesive layer, for example. The thickness of the adhesive layer is, for example, from 10 μm to 150 μm and, particularly preferably, from 50 μm to 75 μm. Such carrier films, cover films, and/or insulation films are particularly suitable for electrically insulating and mechanically stabilizing the conductor tracks and protecting them from mechanical damage and corrosion.

The electrical conductor tracks and/or the auxiliary conductor tracks of the ribbon cable preferably contain or consist of a metallic material—for example, copper, aluminum, stainless steel, tin, gold, silver, or alloys thereof. If the electrical conductor tracks are produced as strips from a metal film, the metal can be tin-plated in sections or completely. This is particularly advantageous for achieving good solderability with simultaneous corrosion protection. In addition, contacting with an electrically-conductive adhesive is improved.

According to one embodiment, the electrical conductor tracks and/or the auxiliary conductor track have a thickness dL of 10 μm to 300 μm, preferably of 10 μm to 150 μm, particularly preferably of 30 μm to 250 μm, and in particular of 50 μm to 150 μm. Such thin conductors are particularly flexible and can, for example, be easily laminated into and led out of laminated glass panes. According to one embodiment, the electrical conductor tracks and/or the auxiliary conductor track have a width bL of 0.05 mm to 40 mm, preferably of 1 mm to 20 mm, and in particular of 2 mm to 5 mm. Such widths are particularly suitable for achieving sufficient current-carrying capacity in conjunction with the aforementioned thicknesses.

Such ribbon cables are so thin that they may be embedded in and led out of the thermoplastic intermediate layer of a laminated glass pane without difficulty between the individual panes. Thus, the ribbon cable is particularly suitable for contacting electrical functional elements in laminated glass panes.

Each electrical conductor track can be electrically contacted at two contact points spaced apart along the conductor track. The contact points are regions of the conductor tracks where electrical contact is possible. In the simplest embodiment, these are accessible regions of the electrical conductor tracks. The first connector region has a contact point of at least one of the electrical conductor tracks. The second connector region is typically, but not necessarily, on the same side as the first connector region of the ribbon cable. The at least one second connector region has a contact point of at least one of the electrical conductor tracks. The connector regions of the ribbon cable are used for electrical contacting of the conductor tracks, for which purpose any cover film and possibly insulation film or carrier film is not present or removed at least at the contact points, so that the conductor tracks are accessible.

It is understood that the connector regions may be protected from corrosion by an electrically-conductive coating, such as tin plating, or a non-electrically-conductive layer, such as a solder lacquer. Such protective layer is usually not removed, burned, or otherwise penetrated until electrical contact is made, in order to enable electrical contact. Insulation-free connector regions can be produced by windowing techniques during production or by subsequent removal—for example, by means of laser ablation or mechanical removal. With the windowing technique, the conductor tracks are coated, e.g., pasted or laminated, onto a carrier film through a cover film with corresponding recesses (windows) in the connector regions. Alternatively, the conductor tracks are laminated on both sides, wherein a cover film has corresponding recesses in the connector regions. In the case of subsequent removal, corresponding recesses can be made in the connector regions in the cover film if the conductor tracks have been applied to a carrier film. In the case of laminated ribbon cables, recesses can be made in the connector regions in a cover film and, if necessary, the carrier film. However, it is also possible for the ribbon cable to have one or more openings in the cover film and possibly in the carrier film in the first connector region and in the second connector region, respectively. Each perforation extends completely onto the conductor track, i.e., it forms a material-free passage onto the conductor track.

The connector regions are formed according to their respective use. In an advantageous embodiment, the contact points are formed as soldering contact points. The electrical line connection between the connector regions of the ribbon cable and the electrical functional element along with the at least one connection region is preferably made by soldering, bonding, welding, clamping, crimping, or plugging. With soldering, soft soldering with a low-melting solder is preferred. Alternatively, the electrically-conductive connection can be made by bonding with an electrically-conductive adhesive or clamps—for example, by means of a metallic clip, sleeve, or plug-in connection. Inside the laminated glass pane, the electrical line connection can also be made by direct contact between the electrically-conductive regions, wherein such assembly is firmly laminated into the laminated glass pane and thus secured against slippage.

Advantageously, the ribbon cable is provided with an electrode array in the first or second connector region, which comprises a plurality of individual electrodes that are electrically connected to the conductor tracks. This enables a simple electrical contacting of the electrical functional element to its specific open-loop/closed-loop control.

In an advantageous embodiment of a connector assembly according to the invention, the ribbon cable in the second connector region comprises one or preferably several electrical connection regions, in which the ribbon cable is detachably or fixedly connected to a connector cable.

Advantageously, in the connection region, the conductor tracks, i.e., the electrical conductor tracks and/or the auxiliary conductor tracks, are electrically connected at the second connector region to electrical cores of one or more connector cables—in particular, round cables. Particularly preferably, the conductor tracks and the cores are electrically connected to one another by solder connections, crimp connections, clamp connections, or plug connections.

The connector cables may in turn have electrical connection means, such as plugs or sockets, at their end facing away from the connection region, which makes it possible to connect the connector assembly to an electrical control unit according to the invention, board electronics, or other control and evaluation units.

In a further advantageous embodiment, the connection region or electrical connection means can be surrounded by one or more protective housings. The protective housing or housings increase the mechanical stability of the connection regions or the connection means—in particular, during the production of the connector assembly—thus reducing the number of defective articles, which in turn corresponds to a savings in cost. Thereby, the at least one protective housing is arranged in such a way that it comes to lie over the one or more connection regions or connection means and is preferably modeled on the outer shape of the connection regions or connection means. Thus, it is possible to achieve a form-fitting enclosure of the connection region or the connection means.

The at least one protective housing serves to mechanically protect the connection region or connection means and is advantageously formed to counteract any deformations of the connection region or connection means during production of the connector assembly—in particular, during lamination of the laminated glass panes under vacuum and at high temperatures. Thereby, the protective housing can consist of a suitably strong plastic—for example, polyimide (PI) or PA66 in combination with glass fibers. Particularly advantageously, the at least one protective housing for this purpose consists of a material that is harder than the material of which the connection regions and means are made. Thereby, the material hardness is determined according to the known common methods, such as ISO 14577, as used at the time of application or at the time of priority.

The protective housing can be produced using injection molding or 3-D printing processes, for example. For example, the protective housing can be bonded to the one or more connection regions. However, joint production with the one or more connection regions is also possible—for example, by injection molding.

The connector assembly according to the invention comprises a laminated glass pane with an electrical functional element arranged inside the laminated glass pane. The electrical functional element can be any electrical structure that performs an electrical function and requires open-loop/closed-loop control by an external control unit, so that the use of a ribbon cable with a plurality of conductor tracks makes technical sense.

Preferably, the electrical functional element is an advantageously large-area, electrically-conductive layer that is advantageously transparent to visible light (electrical functional layer), as described at the beginning. The electrical functional layer or a carrier film with the electrical functional layer can be arranged on a surface of an individual pane. For example, the electrical functional layer is located on an inner surface of one and/or the other pane. Alternatively, the electrical functional layer can be embedded between two thermoplastic films of the intermediate layer. The electrical functional layer is then preferably applied to a carrier film or carrier pane. The carrier film or carrier pane preferably contains a polymer—in particular, polyvinyl butyral (PVB), ethylene vinyl acetate (EVA), polyurethane (PU), polyethylene terephthalate (PET), or combinations thereof.

The electrical functional layer is preferably arranged on a surface of at least one pane and partially covers or overlaps the surface of the pane, but preferably over a large area. The term, “large area,” means that at least 50%, at least 60%, at least 70%, at least 75%, or preferably at least 90% of the surface of the pane is covered by the functional layer. However, the functional layer can also extend over smaller portions of the surface of the pane. The functional layer is preferably transparent to visible light. In an advantageous embodiment, the functional layer is a single layer or a layer structure consisting of several single layers with a total thickness of less than or equal to 2 μm, and particularly preferably less than or equal to 1 μm.

In the sense of the present invention, “transparent” means that the overall transmittance of the glazing unit complies with the legal requirements for windshields and front side panes and preferably has a transmittance for visible light of more than 70% and, in particular, of more than 75%. For rear side panes and rear panes, “transparent” can also mean 10% to 70% light transmission. Accordingly, “opaque” means a light transmission of less than 15%, preferably less than 5%, and in particular 0%.

For example, the electrical functional layer includes at least one metal—preferably silver, nickel, chromium, niobium, tin, titanium, copper, palladium, zinc, gold, cadmium, aluminum, silicon, tungsten, or alloys thereof—and/or at least one metal oxide layer—preferably tin-doped indium oxide (ITO), aluminum-doped zinc oxide (AZO), fluorine-doped tin oxide (FTO, SnO2:F), or antimony-doped tin oxide (ATO, SnO2:Sb). Transparent, electrically-conductive layers are known, for example, from DE 20 2008 017 611 U1 and EP 0 847 965B1. For example, they consist of a metal layer such as a silver layer or a layer of a silver-containing metal alloy. Typical silver layers preferably have thicknesses of 5 nm to 15 nm, and particularly preferably 8 nm to 12 nm. The metal layer can be sandwiched between at least two layers of dielectric material of the metal oxide type. The metal oxide preferably includes zinc oxide, tin oxide, indium oxide, titanium oxide, silicon oxide, aluminum oxide, or the like, along with combinations of one or more thereof. The dielectric material can also include silicon nitride, silicon carbide, aluminum nitride, along with combinations of one or more thereof. The layer structure is generally obtained by a sequence of deposition processes performed by a vacuum method such as magnetic-field-assisted cathode sputtering or by chemical vapor deposition (CVD). Very fine metal layers, which contain titanium or niobium in particular, may also be provided on both sides of the silver layer. The lower metal layer serves as an adhesive and crystallization layer. The upper metal layer serves as a protective and getter layer, in order to prevent the silver from changing during further process steps.

Transparent, electrically-functional layers preferably have a sheet resistance of 0.1 ohm/square to 200 ohm/square, more preferably of 1 ohm/square to 50 ohm/square, and most preferably of 1 ohm/square to 10 ohm/square.

Preferably, the electrical functional layer is an electrically-heatable layer, through which the laminated glass pane is provided with a heating function. Such heatable layers are known to the skilled person per se. They typically contain one or more, e.g., two, three, or four, electrically-conductive layers. Such layers preferably contain or consist of at least one metal, e.g., silver, gold, copper, nickel, and/or chromium, or a metal alloy, and preferably contain at least 90 wt % of the metal, and in particular at least 99.9 wt % of the metal. Such coatings exhibit particularly advantageous electrical conductivity with simultaneous high transmission in the visible spectral range. The thickness of a single layer is preferably from 5 nm to 50 nm, and more preferably from 8 nm to 25 nm. With such a thickness, an advantageously high transmission in the visible spectral range and a particularly advantageous electrical conductivity are achieved.

The electrical functional element can equally preferably be an electro-optical component, such as an electrochromic (EC) element, an SPD element, a PDLC element, or a guest-host element, as described at the beginning. These are known to the person skilled in the art per se, so that they do not need to be explained in detail. The electrical functional layer can also be a polymeric, electrically-conductive layer—for example, containing at least one conjugated polymer or a polymer provided with conductive particles.

Electro-optical components, such as electrochromic elements, SPD, PDLC, or so-called guest-host elements, are commercially available as multilayer films, wherein the active layer is arranged between two surface electrodes used to apply a voltage to control the active layer. As a rule, the two surface electrodes are arranged between two carrier films—typically made of PET. Commercially available multilayer films are also covered on both sides with a protective film made of polypropylene or polyethylene, which serve to protect the carrier films from soiling or scratching. During the production of the laminated glass pane, the electro-optical component is cut out of the multilayer film in the desired size and shape and inserted between the films of an intermediate layer, by means of which two glass panes are laminated to one another to form the laminated glass pane. A typical application is that of windshields with electrically-controllable sunscreens, which are known for example from DE 102013001334A1, DE 102005049081B3, DE 102005007427A1, and DE 102007027296A1 .

Alternative electrical functional elements include LED or OLED lighting elements or photovoltaic components such as (thin-layer) solar cells or antenna systems.

In the connector assembly according to the invention, the electrical functional element is advantageously electrically connected to at least two busbars through which a current can be fed. The busbars are preferably arranged in the marginal region of the electrical functional element. The length of the busbar is typically substantially equal to the length of the respective side edge of the electrical functional element, but may be slightly larger or smaller. Preferably, two busbars are arranged in the marginal region along two opposite side edges of the functional element. The width of the busbars is preferably from 2 mm to 30 mm, and more preferably from 4 mm to 20 mm. The busbars are typically each in the form of a strip, wherein the longer of its dimensions is referred to as the length, and the less long of its dimensions is referred to as the width. Such busbars are, for example, formed as a printed and burned-in conductive structure. The imprinted busbar contains at least one metal—preferably silver. The electrical conductivity is preferably realized via metal particles contained in the busbar, and particularly preferably via silver particles. The metal particles may be in an organic and/or inorganic matrix such as pastes or inks, and preferably as a fired screen printing paste with glass frits. The layer thickness of the imprinted busbar is preferably from 5 μm to 40 μm, more preferably from 8 μm to 20 μm, and most preferably from 10 μm to 15 μm. Imprinted busbars with such thicknesses are technically simple to realize and have an advantageous current-carrying capacity. Alternatively, the busbar can also be formed as a strip of electrically-conductive film. The busbar then contains, for example, at least aluminum, copper, tin-plated copper, gold, silver, zinc, tungsten, and/or tin, or alloys thereof. The strip preferably has a thickness of 10 μm to 500 μm, and particularly preferably 30 μm to 300 μm. Busbars made of electrically-conductive films with such thicknesses are technically simple to realize and have an advantageous current-carrying capacity. The strip can be electrically-conductively connected to the electrically-conductive structure, e.g., via a solder compound, via an electrically-conductive adhesive, or by direct application.

The laminated glass pane of the connector assembly according to the invention comprises a first pane and a second pane, which are preferably made of glass, and particularly preferably soda-lime glass, as is customary for window panes. However, the panes may also be manufactured from other types of glass, e.g., quartz glass, borosilicate glass, or alumino-silicate glass, or from rigid clear plastics—for example, polycarbonate or polymethyl methacrylate. The panes may be clear, or also tinted or colored. If the laminated glass pane is used as a windshield, it should have sufficient light transmission in the central viewing region—preferably at least 70% in the main viewing region A according to ECE-R43. The first pane and the second pane can also be referred to as the outer and inner panes.

The first pane, the second pane, and/or the intermediate layer may have other suitable coatings known per se—for example, anti-reflective coatings, non-stick coatings, anti-scratch coatings, photocatalytic coatings or sun protection coatings, or low-e coatings.

The thickness of the first pane and the second pane can vary widely and thus be adjusted to the requirements in an individual case. The first pane and the second pane advantageously have standard thicknesses of 0.7 mm to 25 mm—preferably of 1.4 mm to 2.5 mm for automotive glass and preferably of 4 mm to 25 mm for furniture, appliances, and buildings, and in particular for electric radiators. The size of the panes can vary widely and depends upon the size of the use according to the invention. The first and second panes have areas of 200 cm² to 20 m², for example, which are common in the automotive and architectural sectors.

In a further advantageous embodiment of a ribbon cable according to the invention or of a connector assembly according to the invention, a protective film, protective body, or protective compound—preferably made of an epoxy resin or a buthyl material—is arranged on and/or around the temperature sensor or on the surface, facing away from the temperature sensor, of the ribbon cable and, in particular, of the carrier film. This has the particular advantage of protecting the temperature sensor, the electrical line connections between the temperature sensor and the auxiliary conductor tracks, and the auxiliary conductor tracks in the vicinity of the temperature sensor from damage during lamination.

A further aspect of the invention relates to a control system that has at least:
a connector assembly according to the invention and
an electrical control unit that is electrically connected to the auxiliary conductor tracks and the at least one electrical conductor track,
   wherein
   the electrical control unit is formed for
measuring an ohmic resistance value R_{Mess} between the ends of the auxiliary conductor tracks and,
as a function of the measured resistance value R_{Mess},
controlling the electrical functional element and/or
detecting a defect—preferably a break and/or a short circuit—of the auxiliary conductor tracks with a temperature sensor arranged in-between.

The control unit according to the invention is formed to measure the ohmic resistance R_{Mess} between the auxiliary conductor tracks with a temperature sensor arranged in-between—in particular, via the connectors in the second connector region of the ribbon cable. The control unit according to the invention can then—taking into account the inherent resistance of the auxiliary conductor tracks and further resistances of the supply lines, plugs, etc.—infer the resistance value of the temperature sensor and, as a result, the temperature T at the temperature sensor. For this purpose, the resistance-temperature characteristic curve or a table is stored in the electrical control unit. The temperature can be measured either selectively or continuously.

Advantageously, the control unit is also connected to the electrical conductor tracks, with which an electrical functional element connected via the connector regions can be electrically operated and controlled.

The control unit is advantageously formed to adjust the control voltages S for the electrical functional element to the measured temperature T at the temperature sensor. The suitable control voltage S can, for example, be calculated by the electrical control unit or stored or programmed into the electrical control unit by means of tables. For example, if a certain temperature T is exceeded, the control voltage S can be reduced or completely switched off in order to protect the electrical functional element. This is in particular advantageous for a PDLC element as an electrical functional element. Alternatively, the control voltage S can be increased—for example, in order to maintain an optical coloration or transparency change that decreases with increasing temperature, or to increase a rate of change.

Furthermore, by measuring the ohmic resistance R_{Mess} of the additional cable with a temperature sensor arranged in-between (for example, via connectors in the second connector region), it is possible to conclude that the ribbon cable and the electrical conductor tracks contained therein are damaged. The measurement can be carried out selectively or continuously.

If an ohmic resistance R_{Mess} is measured above an upper reference resistance value R_{Ref_o}, this indicates a break or defect in the measuring circuit consisting of auxiliary conductor tracks and a temperature sensor.

Example: When measuring the ohmic resistance R_{Mess} on undamaged additional lines with a temperature sensor in the form of an NTC thermistor with an R₂₅ of, for example, 10 kOhm at 25° C., an upper resistance R_{Ref_o} of approximately 200 kOhm is obtained at a temperature T at the lower operating range of, for example, −40° C. If such reference resistance value R_{Ref_o} is exceeded, e.g., by 10%, this indicates a break or defect in the measuring circuit consisting of auxiliary conductor tracks and a temperature sensor, from which a defect in the ribbon cable can be inferred.

If an ohmic resistance R_{Mess} is measured below a lower reference resistance value R_{Ref_u}, this indicates a short circuit in the measuring circuit consisting of auxiliary conductor tracks and a temperature sensor.

Example: When measuring the ohmic resistance R_{Mess} of undamaged additional lines with a temperature sensor in the form of an NTC thermistor with an R₂₅ of, for example, 10 kOhm at 25° C., a lower resistance R_{Ref_u} of approximately 300 ohms is obtained at a temperature T at the upper operating range of, for example, 150° C. If such lower reference resistance value R_{Ref_u} is not reached, this indicates a short circuit in the measuring circuit consisting of auxiliary conductor tracks and a temperature sensor, from which a defect in the ribbon cable can also be inferred.

A further aspect of the invention relates to a method of producing a connector assembly according to the invention, and comprises the following steps:
a) Providing a ribbon cable according to the invention with electrical conductor tracks and two auxiliary conductor tracks with a temperature sensor arranged in-between, wherein the ribbon cable has a first connector region at a first end and a second connector region at a second end,
b) Electrically conductively connecting the conductor tracks of the ribbon cable in the first connector region to an electrical functional element,
c) Arranging the ribbon cable between two panes in such a way that the first connector region is located between the two panes, and the second connector region is led out between the two panes,
d) Laminating the two panes via a thermoplastic intermediate layer according to steps a), b), and c).

Steps a), b), and c) may be performed in any order.

According to one embodiment of the method according to the invention, before or after the lamination of the two panes, an electrical connection region is formed—preferably by solder connections, crimp connections, clamp connections, or plug connections—between the second connector region of the ribbon cable and a connector cable—in particular, a round cable.

The connection of the two individual panes during lamination is preferably carried out under the action of heat, vacuum, and/or pressure. Methods known per se for producing a laminated glass pane can be used. For example, so-called autoclave methods may be carried out at an elevated pressure of approximately 10 bar to 15 bar and temperatures of 130° C. to 145° C. for approximately 2 hours. Vacuum bag or vacuum ring methods known per se operate, for example, at approximately 200 mbar and 80° C. to 110° C. The first pane, the thermoplastic intermediate layer, and the second pane can also be pressed in a calender between at least one roller pair to form a pane. Systems of this type for the production of panes are known and usually have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more chambers that can be heated and evacuated, in which the first pane and the second pane are laminated within, for example, approximately 60 minutes at reduced pressures of 0.01 mbar to 800 mbar and temperatures of 80° C. to 170° C.

A further aspect of the invention relates to a method for measuring the temperature of a ribbon cable or connector assembly according to the invention, wherein
a) a ribbon cable according to the invention, a connector assembly according to the invention, or a control system according to the invention is provided,
b) the ohmic resistance between the ends of the auxiliary conductor tracks with a temperature sensor arranged in-between is measured, wherein the measured resistance value R_{Mess} corresponds to a temperature T at the temperature sensor.

In an advantageous embodiment of the method according to the invention, the control voltage S of the electrical functional element according to the invention, which is electrically connected to the ribbon cable according to the invention, is selected as a function of the temperature measurement.

In a further advantageous embodiment of the method according to the invention, step b) is carried out repeatedly, and preferably continuously, and the control voltage S is adjusted accordingly.

In a further advantageous embodiment of the method according to the invention, in a step c) before or after step b), the measured resistance value R_{Mess} is compared with a reference resistance value R_{Ref_u/o}, wherein exceeding or falling below the reference resistance value R_{Ref_u/o} corresponds to a defect, and preferably a break or a short circuit, in the ribbon cable.

Particularly preferably, step c) is carried out before and/or after the ribbon cable according to the invention is arranged in a connector assembly.

A further aspect of the invention relates to a method for detecting breaks of a ribbon cable or connector assembly according to the invention, wherein
a) a ribbon cable or connector assembly according to the invention is provided,
b) a reference ohmic resistance value R_{Ref_u/o} is measured or calculated between the ends of the—preferably undamaged—auxiliary conductor track,
c) the ohmic resistance R_{Mess} between the ends of the auxiliary conductor track is measured, and the resistance R_{Mess} is compared with the reference resistance R_{Ref_u/o}.

In an advantageous embodiment of the method according to the invention, the ribbon cable is considered defective if the measured ohmic resistance R_{Mess} deviates from the reference ohmic resistance value R_{Ref_u/o} by more than 5%, preferably more than 10%, and particularly preferably more than 50%. In particular, the ribbon cable is considered defective if the measured ohmic resistance R_{Mess} is higher than upper ohmic reference resistance value R_{Ref_o} by more than 5%, preferably more than 10%, and particularly preferably more than 50%, and/or lower than a lower ohmic reference resistance value R_{Ref_u} by more than 5%, preferably more than 10%, and particularly preferably more than 50%. Thereby, the ohmic reference resistance values depend upon the resistance range of the temperature sensor in the respective operating range and upon the characteristics of the temperature sensor—in particular, whether it is a temperature sensor with negative temperature coefficients (NTC's) or with positive temperature coefficients (PTC's).

The ohmic reference resistance value R_{Ref_u/o} can be easily calculated or measured by the person skilled in the art. If the auxiliary conductor track is damaged, the measured resistance values R_{Mess} are typically higher than the reference resistance value R_{Ref_o}. This can indicate a defect in the ribbon cable and, in particular, an interruption in the conductor tracks. Measured ohmic resistance values R_{Mess} lower than the reference resistance value R_{Ref_u} may indicate a short circuit within the ribbon cable.

In an advantageous embodiment of the method according to the invention, step c) is carried out before and/or after the ribbon cable is arranged in a connector assembly.

In a further advantageous embodiment of the method according to the invention, step c) is carried out repeatedly.

A further aspect of the invention relates to the use of a ribbon cable according to the invention, a connector assembly according to the invention, or a control system according to the invention as a building glazing unit or a vehicle glazing unit—preferably as a vehicle glazing unit, and in particular as a windshield or a roof pane of a motor vehicle.

Another aspect of the invention relates to the use of a ribbon cable according to the invention, a connector assembly according to the invention, or a control system according to the invention for temperature measurement or for combined temperature measurement and defect detection—in particular, for the detection of breaks and/or short circuits.

The various embodiments of the invention may be implemented individually or in any combinations. In particular, the features mentioned above and to be explained below can be used not only in the specified combinations, but also in other combinations or alone without departing from the scope of the present invention.

The invention is explained in more detail below with reference to exemplary embodiments, wherein reference is made to the accompanying figures. Elements that are identical or have the same effect are provided with the same reference sign. In a simplified, not-to-scale representation:

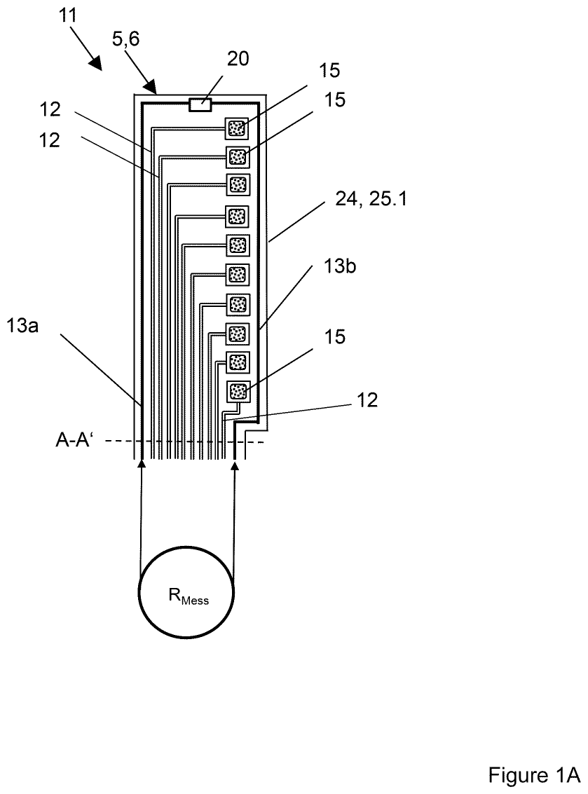

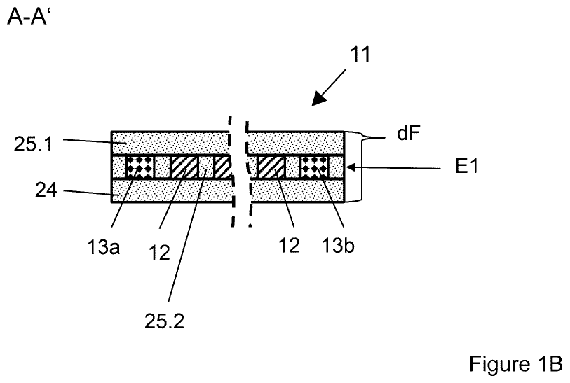

FIG. 1A shows a schematic representation of the first connector region of a ribbon cable according to the invention,

FIG. 1B shows a schematic cross-sectional representation along the section line A-A′ of the ribbon cable of the invention according to FIG. 1A,

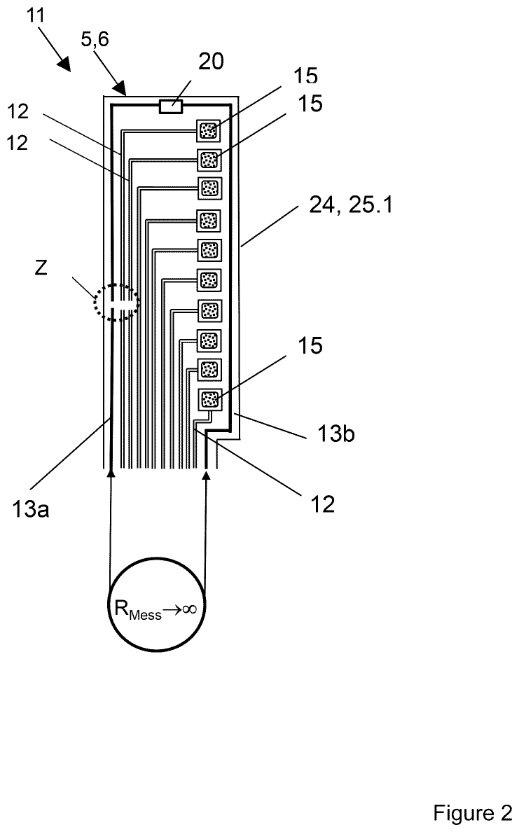

FIG. 2 shows a schematic representation of the ribbon cable according to FIG. 1A with a defect,

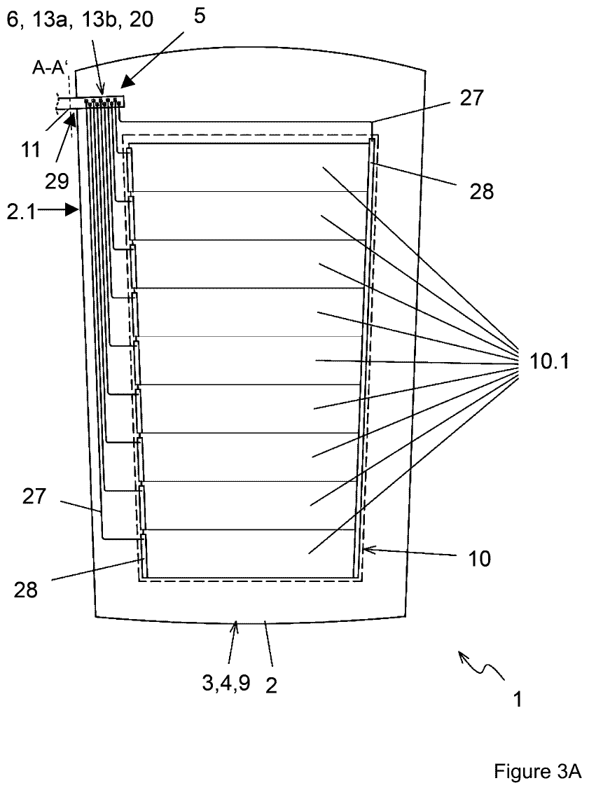

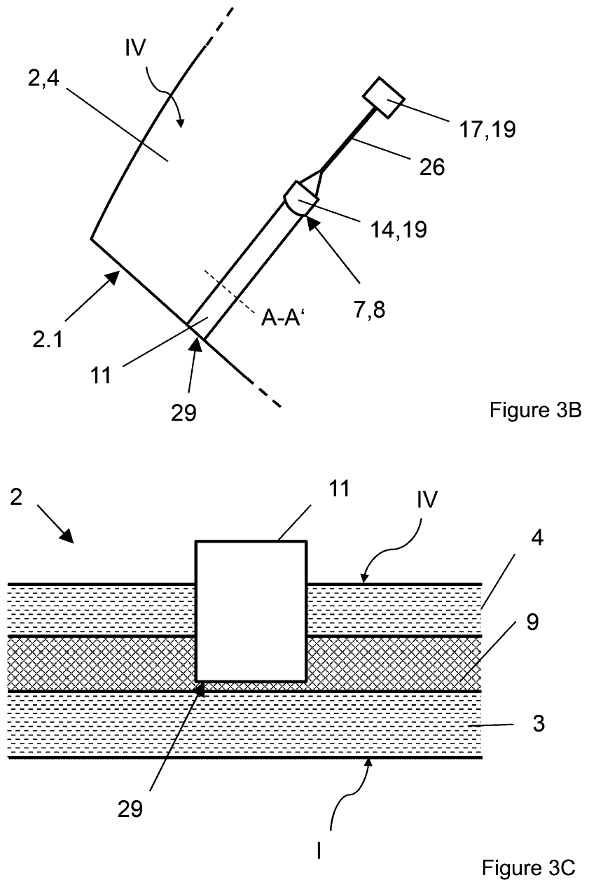

FIG. 3A shows a schematic top view of a laminated glass pane of a connector assembly according to the invention,

FIG. 3B shows a cutout of the connector assembly of FIG. 3A, and

FIG. 3C shows a cutout of the connector assembly of FIG. 3A on a side surface of the laminated glass pane, and

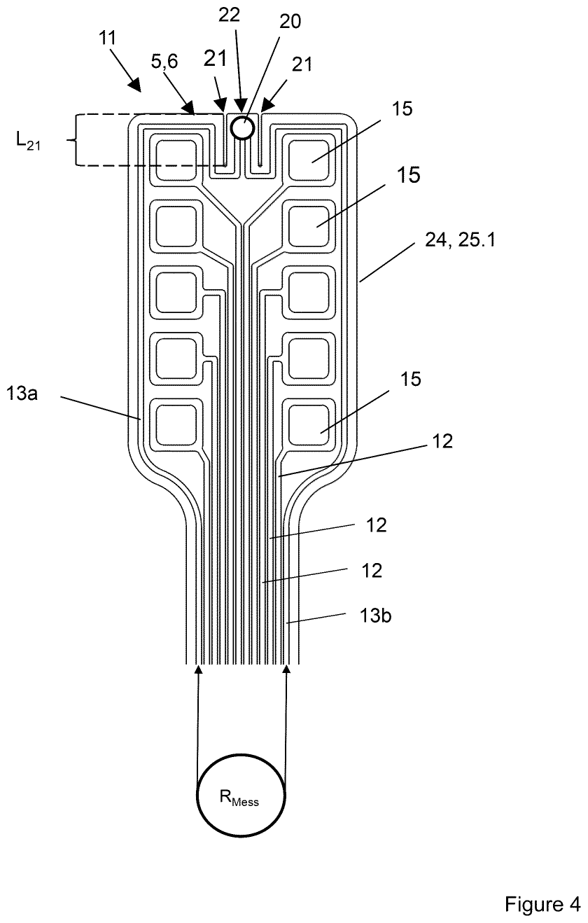

FIG. 4 shows a schematic representation of the first connector region of an alternative ribbon cable according to the invention.

Reference is initially made to FIGS. 1A, 1B, and 2, wherein a ribbon cable designated overall by reference number 11 is illustrated in a schematic manner.

FIG. 1A shows a schematic representation of the first connector region 6 of a ribbon cable 11 according to the invention. The first connector region 6 is located at a first end 5 of the ribbon cable 11.

FIG. 1B shows a schematic cross-sectional representation along the section line A-A′ of the ribbon cable 11 according to FIG. 1A.

Ten electrical conductor tracks 12, for example, are arranged on a polymeric carrier film 24 and are bonded to the carrier film 24, for example. The electrical conductor tracks 12 each open into a connector electrode 15. Furthermore, two auxiliary conductor tracks 13a, 13b are guided on the carrier film 24 in a substantially U-shaped manner around the first connector region 6 in the marginal region of the carrier film 24. The auxiliary conductor tracks 13a, 13b each contact one of the two connectors of a temperature sensor 20, which is arranged here, for example, in the middle of the first end 3 of the ribbon cable 11.

For example, the temperature sensor 20 is a thermistor, which is an electrical resistor whose value changes reproducibly with temperature. The thermistor is, for example, an NTC thermistor, i.e., a so-called hot conductor, which has a negative temperature coefficient (NTC) and conducts electricity better in the hot state than in the cold state. The thermistor preferably has a resistance value R₂₅ of 1 kOhm to 100 kOhm, and, for example, 10 kOhm. This typically allows temperatures T from −40° C. to +150° C. to be measured reproducibly. The temperature sensor 20 is preferably designed using SMD technology and has only a small thickness.

The auxiliary conductor tracks 13a, 13b and the temperature sensor 20 are bonded to the carrier film 24, for example. The distance between the auxiliary conductor tracks 13a, 13b and the margin of the carrier film 24 is, for example, 3 mm.

The electrical conductor tracks 12 and the auxiliary conductor tracks 13a, 13b consist, for example, of a thin copper, silver, tin, or gold film. The films can be additionally coated—for example, silver-plated, gold-plated, or tin-plated. The thickness of the films is, for example, 35 μm, 50 μm, 75 μm, or 100 μm.

The carrier film 24, the electrical conductor tracks 12, the auxiliary conductor tracks 13a, 13b, and preferably also the temperature sensor 20 are covered with a cover film 25.1 and preferably bonded thereto. This results in a ribbon cable 11 with embedded conductor tracks 12, 13a, 13b, which are electrically insulated from the outside. The cover film 25.1 or the carrier film 24 are typically recessed in the regions of the connector electrodes 15, so that the ribbon cable 11 can be electrically contacted there. Further sections of an insulation film 25.2 may be arranged between the individual conductor tracks 12, 13a, 13b and between the auxiliary conductor tracks 13a, 13b and the margin of the carrier film 24.

For the material of the carrier film 24, films made of polyimide preferably black or yellow polyimide films (e.g., PI-MTB/MBC), e.g., with a thickness of 25 μm or of 50 μm—are particularly suitable. Alternatively, polymer films made of PEN—preferably white, black, or transparent PEN, e.g., with a thickness of 25 μm—may be used.

Films made of polyimide—preferably black or yellow polyimide films (e.g., PI-MTB/MBC), e.g., with a thickness of 25 μm—are particularly suitable for the material of the cover film 25.1 and possibly as insulation film 25.2. Alternatively, polymer films made of PEN—preferably white PEN, e.g., with a thickness of 25 μm—may be used.

Adhesive layers between the carrier film 24, the cover film 25.1, the insulation film 25.2, the electrical conductor track 12, and/or the auxiliary conductor tracks 13a, 13b may, for example, contain or consist of epoxy adhesives or thermoplastic adhesives. Typical thicknesses of adhesive films are from 25 μm to 35 μm. The adhesives may be transparent or colored-for example, black.

By measuring the electrical resistance value and in particular the ohmic resistance value R_{Mess} between the auxiliary conductor tracks 13a, 13b with temperature sensor 20 arranged in-between (for example, via connectors in the second connector region 8), taking into account the inherent resistance of the auxiliary conductor tracks 13a, 13b and further resistances of the supply lines, plugs, etc., it is possible to infer the resistance value of the temperature sensor 20 and, as a result, the temperature T at the temperature sensor 20.

For this purpose, the resistance-temperature characteristic curve or a table can be stored in an electrical control unit (not shown here), which is electrically connected to the connectors of the auxiliary conductor tracks 13a, 13b and with which the resistance measurement is carried out.

The control unit can also be connected to the electrical conductor tracks 12, which can be used to electrically operate and control an electrical functional element 10 connected via the connector regions 15.

The control unit can be formed, for example, to adjust the control voltages S for the electrical functional element 10 to the measured temperature T at the temperature sensor 20. For example, when a certain temperature T is exceeded, the control voltage can be reduced or completely shut off in order to protect the electrical functional element 10. This is particularly advantageous for a PDLC element as an electrical functional element 10. Alternatively, the control voltage S can be increased—for example, in order to maintain an optical coloration or transparency change that decreases with increasing temperature.

Furthermore, by measuring the ohmic resistance R_{Mess} of the additional line 13a, 13 b, e.g., via connectors in the second connector region 8, it is possible to conclude that the ribbon cable 11 and the electrical conductor tracks 12 contained therein are damaged. The measurement can be carried out selectively or continuously. When measuring the ohmic resistance R_{Mess} of undamaged additional lines 13a, 13b with a temperature sensor 20 in the form of an NTC thermistor with an R₂₅ of 10 kOhm, for example, an upper resistance R_{Ref_o} of approximately 200 kOhm is obtained at a temperature T at the lower operating range of, for example, −40° C. If such reference resistance value R_{Ref_o} is significantly exceeded, this indicates a break or defect in the measuring circuit consisting of auxiliary conductor tracks 13a, 13b and a temperature sensor 20, from which a defect of the ribbon cable 11 can be inferred. When measuring the ohmic resistance R_{Mess} of undamaged additional lines 13a, 13b with a temperature sensor 20 in the form of an NTC thermistor with an R₂₅ of, for example, 10 kOhm, a lower resistance R_{Ref_u} of approximately 300 ohms is obtained at a temperature T at the upper operating range of, for example, 150° C. If such lower reference resistance value R_{Ref_u} is clearly not reached, this indicates a short circuit in the measuring circuit consisting of auxiliary conductor tracks 13a, 13b and a temperature sensor 20, from which a defect, e.g., a short circuit, in the ribbon cable 11 can also be inferred.

FIG. 2 shows a schematic representation of the ribbon cable 11 according to FIG. 1A with a defect in a break region Z. In the break region Z, the two electrical conductor tracks 12 arranged on the left in the figure and the auxiliary conductor tracks 13a, 13b are damaged and interrupted. The measured ohmic resistance value R_{Mess} of the auxiliary conductor tracks 13a, 13b with the temperature sensor 20 is then very high, and typically in the higher kiloohm (kOhm) or megaohm (MOhm) range.

Such damage often results from excessive stress on the ribbon cable 11—for example, after laminating it into a laminated glass pane and bending the ribbon cable 11 around a pane edge.

Reference is further made to FIGS. 3A, 3B, and 3C, wherein a connector assembly designated overall by reference number 1 is illustrated in a schematic manner.

Here, FIG. 3A shows a view through a laminated glass pane marked with the reference number 2.

FIG. 3B shows a cutout of the laminated glass pane 2 in a top view in the region in which a ribbon cable 11 according to the invention is led out of the side surface 2.1 of the laminated glass pane 2.

FIG. 3C shows a cutout of the connector assembly 1 of FIG. 3A in detail view on a side surface 2.1 of the laminated glass pane 2.

The connector assembly 1 comprises a laminated glass pane 2, which is formed here, for example, as a roof pane of a motor vehicle. As shown schematically in FIG. 3C, the laminated glass pane 2 comprises a first pane 3 serving as an outer pane and a second pane 4 serving as an inner pane. The inner pane is the pane facing the vehicle interior, while the outer pane faces the vehicle environment. The surface, facing the vehicle environment, of the outer pane (first pane 3) is referred to as surface I, as is customary in vehicle glazing technology, and the surface, facing the vehicle interior, of the inner pane (second pane 4) is referred to as surface IV. The two panes 3, 4 consist, for example, of soda-lime glass. The two panes 3, 4 are firmly connected to one another by two, thermoplastic, intermediate layers 9 made, for example, of polyvinyl butyral (PVB), ethylene vinyl acetate (EVA), or polyurethane (PU).

The laminated glass pane 2 is provided with an electrical functional element 10, which is likewise shown only schematically and is located between the two panes 3, 4. Here, the electrical functional element 10 is, for example, a PDLC element that serves, for example, as an electrically-controllable sunshade or privacy screen. The PDLC element is formed by a commercially available PDLC multilayer film, which is embedded in the intermediate layer 9. For this purpose, the intermediate layer 9 comprises, for example, a total of three thermoplastic films (not shown) with a thickness of, for example, 0.38 mm of PVB, wherein a first thermoplastic film is connected to the first pane 3, and a second thermoplastic film is connected to the second pane 4, and wherein a thermoplastic frame film in-between has a cutout into which the cut-to-size functional element 10 is inserted with an accurate fit. The third thermoplastic film thus forms as it were a kind of mount for the functional element 10, which is thus encapsulated all around in thermoplastic material and protected thereby. This embedding of the PDLC element in a laminated glass pane 2 is well known to the person skilled in the art, so that a detailed representation is unnecessary. As is further known to the person skilled in the art, as a rule, the PDLC element comprises an active layer between two surface electrodes and two carrier films. The active layer contains a polymer matrix with liquid crystals dispersed therein, which align as a function of the electrical voltage S applied to the surface electrodes, whereby the optical properties may be controlled.

Here, for example, the functional element 10 is divided into nine segments 10.1 by insulation lines. The segments 10.1 are formed to be strip-shaped. For example, the insulation lines between the segments 10.1 have a width of 40 μm (micrometers) to 50 μm. They may, for example, have been introduced into the prefabricated multilayer film by means of a laser.

In particular, the insulation lines separate the surface electrodes of the functional element 10 into strips that are insulated from one another, each having a separate electrical connector. Thus, the segments 10.1 can be switched independently of one another.

The respective surface electrodes of the segments 10.1 are contacted individually on one side via sections of busbars 28 (shown on the left in FIG. 1) and on the opposite side via a common busbar 28 (shown on the right in FIG. 1). Thus, to apply a voltage to the respective individual busbar sections of the new segments 10.1 and the one common busbar 28, ten independent electrical line connections are required here, for example.

The laminated glass pane 1 further has a ribbon cable 11. The busbars 28 of the segments 10.1 of the functional element 10 are each electrically-conductively connected to the ribbon cable 11, for example, via electrical conductor wires 27. Thereby, a secure, electrically-conductive connection is preferably achieved by soldering the connection.

The functional element 2 is a PDLC functional element that functions as an adjustable sunshade or privacy screen. Depending upon the position of the sun, the driver or another vehicle occupant can operate the PDLC functional element via a touch control, for example.

To control the nine independent segments 10.1 with a common counter-pole, the ribbon cable 11 has, for example, ten, electrically-insulated electrical conductor tracks 12.

It is understood that the ribbon cable 11 can be adjusted to the particular circumstances of actual use and can, for example, extend over two, three, or four planes. Alternatively or in combination, more or fewer conductor tracks per layer can be arranged next to one another.

As illustrated in the schematic insertion of FIG. 3B, the ribbon cable 11 is partially laminated into the laminated glass pane 2 and leads out of the laminated glass pane 2 between the two panes 3, 4. In FIG. 3B, the ribbon cable 11 is routed around the side surface 2.1 of the second pane 4 and is arranged on the surface IV of the second pane 4. For this purpose, the second pane 4 can have a recess in the exit region—for example, through a ground region (not shown here).

The ribbon cable 11 has a first connector region 6 and a second connector region 8, wherein, along a direction of extension of the ribbon cable 11, the first connector region 6 is located at a first end 5 and the second connector region 8 is located at a second end 7 of the ribbon cable 11. In the first connector region 6, the ribbon cable 11 has an electrode array with ten connector electrodes 15 for electrical (e.g., galvanic) contacting of the functional element 10.

The ribbon cable 11 has a second connector region 8 at its second end 7. This is connected to a round cable 26 via a connector element 14 in such a way that, for example, the individual conductor tracks 12 and the two ends of the auxiliary conductor tracks 13a, 13b are each electrically contacted with individual wires of the round cable 26. At the end, facing away from the connector element 14, of the round cable 26, the connector element 17, e.g., a plug or a socket for further electrical connection, e.g., with board electronics, can, for example, be arranged.

For example, the connector element 14 and/or the connector element 17 may be arranged within a protective housing 19 that protects the connector element 17 and/or the connector element 17 from mechanical damage during the lamination process.

FIG. 4 shows a schematic representation of the first connector region 6 of an alternative ribbon cable 11 according to the invention. The ribbon cable 11 according to the invention corresponds substantially to the ribbon cable 11 as shown in FIGS. 1A and 1B, so that only the differences are discussed here, and otherwise reference is made to the description for FIGS. 1A and 1B. It is understood that the alternative ribbon cable 11 of FIG. 4 can also be used in a connector assembly 1 according to FIGS. 3A-C. In addition, the methods according to the invention for temperature measurement and defect detection (break detection and short-circuit detection) can also be carried out with the ribbon cable 11 according to FIG. 4, as set out in the description for FIGS. 1A and 1B.

With the ribbon cable 11 according to FIG. 4, the first connector region 6 is located at a first end 5 of the ribbon cable 11 and has ten connector electrodes 15 arranged in two symmetrical rows on one side of the carrier film 24. Each connector electrode 15 is electrically connected to a conductor track 12.

The ribbon cable 11 according to FIG. 4 has a temperature sensor 20 at the first end 5, which sensor is electrically contacted by two auxiliary conductor tracks 13a, 13b. The temperature sensor 20 is arranged in a section 22 of the ribbon cable 11 in which the carrier film 24 has two notches 21 extending substantially orthogonally from the margin of the carrier film 24 in the direction of the interior of the carrier film 24. For this purpose, the auxiliary conductor tracks 13a, 13b are routed in a loop shape around the notches 21. For example, the length L₂₁ of the notches 21 is approximately 8 mm, and the width is approximately 0.5 mm.

The notches 21 make the section 22 with the temperature sensor 20 particularly flexible. This has the particular advantage that the temperature sensor 20, which is usually thicker than the rest of the connector region 6, can be laminated into a laminated glass pane 2 particularly well.

The particular advantage of the invention is a single ribbon cable 11 according to the invention that provides two functionalities in one component: 1) the supply of an electrical functional element 10 of an active glazing unit with a control voltage S, and 2) a temperature measurement of the active glazing unit and adjusted control of the electrical functional element 10.

This temperature measurement is particularly important for electrical functional elements 10 in active glazing units, since, often, the optical performances (transparency change, scattering behavior, switching speed, etc.) depend upon the temperature of the glazing unit. An electronic power supply through a correspondingly programmed or configured electronic control unit according to the invention can use the results of the temperature measurement and adjust the control voltage S accordingly, in order to regulate the optical powers or simply interrupt the control voltage S if the temperature T is too high or too low, thus protecting the electrical functional element 10 of the active glazing unit from possible damage.

### LIST OF REFERENCE SIGNS

1 Connector assembly
2 Laminated glass pane
2.1 Side or exit surface
3 First pane
4 Second pane
5 First end
6 First connector region
7 Second end
8 Second connector region
9 Intermediate layer
10 Electrical functional element
10.1 Segments
11 Ribbon cable
12 Conductor track
13a, 13b Auxiliary conductor track
14 Connection region
15 Connector electrode
17 Socket or plug
19 Protective housing
20 Temperature sensor
21 Notch
22 Section of the carrier film 24
24 Carrier film
25.1 Cover film
25.2 Insulation film
26 Round cable
27 Conductor wire
28 Busbar
29 Exit point
bF (Maximum) width of the ribbon cable 11
bL (Maximum) width of the conductor track 12
dF (Maximum) thickness of the ribbon cable 11
dL (Maximum) thickness of the conductor track 12
E1 Plane 1
L₂₁ Length of the notch 21
T Temperature
Z Break region
A-A′ Section line p1 I, IV Surface

1. A ribbon cable with temperature sensor, having:
a carrier film with at least one electrical conductor tracks, wherein the carrier film has a first connector region at a first end and a second connector region at a second end, wherein the first connector region is adapted to be arranged between two panes of a laminated glass pane, and the second connector region is adapted to be led out of the laminated glass pane between the two panes, and wherein the at least one electrical conductor track in the first connector region is adapted to make electrical contact with an electrical functional element,
wherein the carrier film has a temperature sensor and two auxiliary conductor tracks and the two auxiliary conductor tracks make electrical contact with the temperature sensor so that an ohmic resistance value R_{Mess} is measurable between the two auxiliary conductor tracks.

2. The ribbon cable according to claim 1, wherein the temperature sensor is arranged at the first connector region of the carrier film.

3. The ribbon cable according to claim 1, wherein the temperature sensor and/or the two auxiliary conductor tracks are arranged in a marginal region of the carrier film.

4. The ribbon cable according to claim 1, wherein the first auxiliary conductor track, the temperature sensor, and the second auxiliary conductor track are routed in a loop shape.

5. The ribbon cable according to claim 1, wherein at least one electrical conductor track and the auxiliary conductor tracks are arranged in one plane next to one another or in at least two planes one above the other.

6. The ribbon cable according to claim 1, wherein at least one electrical conductor track is arranged on a first surface of an electrically-insulating carrier film, and at least one further conductor track is arranged on the second surface of the carrier film.

7. The ribbon cable according to claim 1, wherein the at least one electrical conductor track, the auxiliary conductor tracks and/or the temperature sensor is fixedly connected to the first or second surface of the carrier film.

8. The ribbon cable according to claim 1, wherein the temperature sensor is a resistance element or resistance thermometer.

9. The ribbon cable according to claim 1, wherein the carrier film has a respective notch or recess on both sides of the temperature sensor, which extends from a margin of the carrier film into the interior of the carrier film.

10. A connector assembly, having:
a laminated glass pane comprising a first pane and a second pane, which are bonded to one another in terms of surface area via at least one thermoplastic intermediate layer,
an electrical functional element which is arranged between the two panes,
a ribbon cable according to claim 1, wherein the first connector region is arranged between the two panes, and the second connector region is led out of the laminated glass pane between the two panes, and wherein the at least one electrical conductor track in the first connector region (6) makes electrical contact with the electrical functional element.

11. The connector assembly according to claim 10, wherein the electrical functional element contains or consists of a PDLC, guest-host, or an electrochromic functional element, an LED or OLED light source, a photovoltaic module, or an antenna.

12. A control system, having:
a connector assembly according to claim 10, and
an electrical control unit electrically connected to the auxiliary conductor tracks and the at least one electrical conductor track,
wherein the electrical control unit is formed for
measuring an ohmic resistance value R_{Mess} of the auxiliary conductor tracks with a temperature sensor arranged in-between, and
as a function of the measured resistance value R_{Mess},
controlling the electrical functional element and/or
detecting a defect in the ribbon cable.

13. A method for temperature measurement, comprising:
a) providing a ribbon cable according to claims 1,
b) measuring the ohmic resistance between the ends of the auxiliary conductor tracks with a temperature sensor arranged in-between, wherein the measured resistance value R_{Mess} corresponds to a temperature T at the temperature sensor.

14. The method according to claim 13, wherein control voltages of the electrical functional element electrically connected to the ribbon cable are selected depending upon the temperature measurement in step b).

15. The method according to claim 13, wherein, in a method step c), the measured resistance value R_{Mess} is compared with an upper reference resistance value R_{Ref_o} and/or with a lower reference resistance value R_{Ref_u}, and exceeding the reference resistance value R_{Ref_o} and/or falling below the lower reference resistance value R_{Ref_u} corresponds to a defect in the ribbon cable.

16. A method comprising providing a ribbon cable according to claim 1 in a building glazing unit or vehicle glazing unit.

17. A method comprising providing a ribbon cable according to claim 1 for temperature measurement or for combined temperature measurement and defect detection.

18. The ribbon cable according to claim 1, wherein the carrier film comprises at least two electrical conductor tracks.

19. The ribbon cable according to claim 4, wherein the first auxiliary conductor track, the temperature sensor, and the second auxiliary conductor track are routed in a substantially U-shape around the first connector region.

20. The ribbon cable according to claim 5, wherein at least one electrical conductor track and the auxiliary conductor tracks are arranged in exactly two or exactly three or exactly four planes one above the other.
